(19) United States
(12) Patent Application Publication
(10) Pub. No.: US 2014/0232640 A1
(43) Pub. Date: Aug. 21, 2014

(54) DYNAMIC RANGE RESETTING

(71) Applicant: Umoove Services Ltd., Jerusalem (IL)

(72) Inventor: Yitzchak KEMPINSKI, Geva Binyamin (IL)

(73) Assignee: Umoove Services Ltd., Jerusalem (IL)

(21) Appl. No.: 14/172,973

(22) Filed: Feb. 5, 2014

Related U.S. Application Data
(60) Provisional application No. 61/760,749, filed on Feb. 5, 2013.

(51) Int. Cl. G06F 3/01

(52) U.S. Cl. CPC G06F 3/011
USPC 345/156

(57) ABSTRACT

A system and method of determining that a movement of an eye, head or body part, as is captured in a series of images, is a movement intended to activate a function, by defining ranges within which the movement is deemed as not intended for function activation, and beyond which the movement is deemed as intended for function activation. The ranges may be adjusted dynamically to account for shifts in a resting position of the eye, head or body part.

### CROSS-REFERENCE TO RELATED APPLICATIONS

This application claims benefit from U.S. Provisional Patent Application No. 61/760,749, filed Feb. 5, 2013, which is incorporated herein by reference.

### BACKGROUND

An imager used to track a movement of a head, eye or other body part for purposes of control of a function of an electronic device or for other functions, may detect small movements of the eye, head or other body part that the user may not want to be interpreted or counted for purposes of the function control. Such movements may be included in an “ignore range” of movements from for example a center point of the body part or from some other point or set of points that designate the ignore range. Movements that are detected as reaching or extending beyond such ignore range into a “function range” may be assumed to be intended by the user to be interpreted by a system for purposes of function control of an electronic device.

Large, exaggerated or unexpectedly pronounced movements of a head, eye or body part may also be detected by an imager. A tracking system may likewise be configured to ignore such large movements for purposes of function control of a device. Such unexpectedly pronounced or exaggerated movements may be deemed beyond the edge of the function range for purposes of function control of an electronic or other device.

In the course of use of a device, a user may alter a position of a head, eye or other body part, or may alter a position of the tracking device such as an imager in a mobile device, or a position of one or both of the body part and device relative to each other, so that there is a change in a center, resting point or resting position or other position or point from which may be derived one or more of an ignore range and a function range. Typically, following a movement of a head, eye or body part, a user may overshoot or otherwise not re-assume the prior or start position of such head, eye or body.

### DESCRIPTION OF THE INVENTION

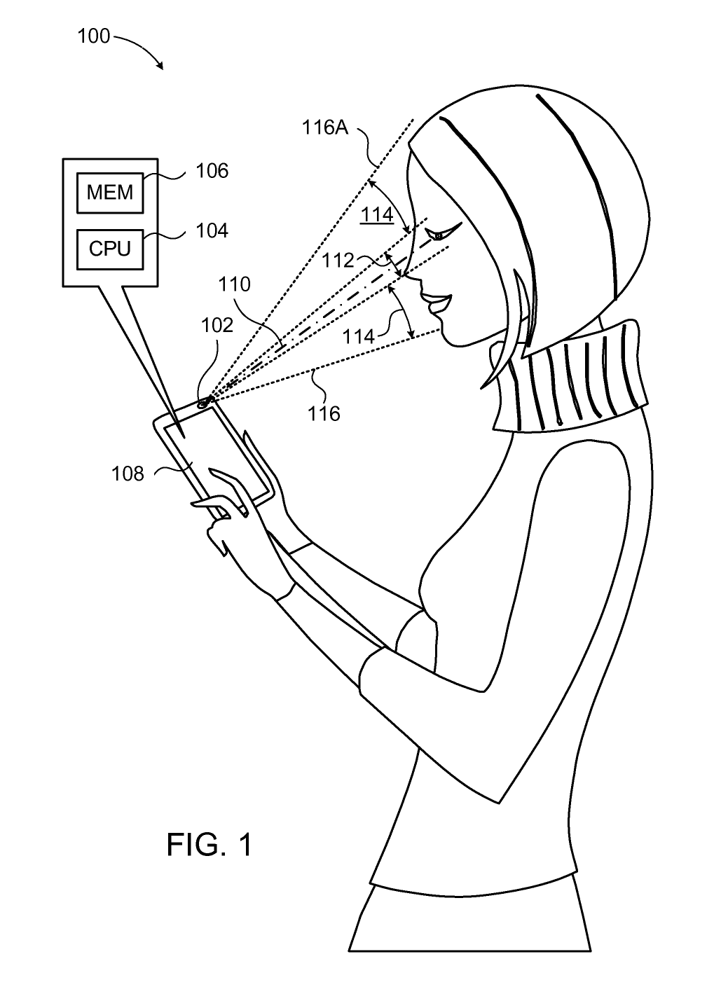

Reference is made to FIG. 1, a schematic depiction of a mobile device having an imager used for tracking of a movement body part such as a head or eye, in accordance with an embodiment of the invention. In FIG. 1, an electronic device 100 may include an imager 102, a processor 104, a memory 106 and a display 108. Imager 102 may capture an image of a body part such as a head or eye of a user, and may locate a coordinate of one or more points on the head or eye when the user is in a resting or initial position. For example, a center point or line 110 may include a position or coordinate that may be in for example a middle of a head or eye or body part or at some other location of the body part relative to the imager 102. A range, such as an ignore range 112 may also be established, such as around or symmetrical to center line 110 or at some other locations or angles, representing an area limit of motions or movements on one or more axis (lateral, vertical, diagonal or other). Motions of the head, eye or body part within this ignore range 112 may be interpreted as not intentional or as not intended for purposes of function activation. Movements or motions of the head, eye or body part beyond ignore range 112 may extend into a function range 112 and may be interpreted as intended or may be counted or considered for purposes of function activation or otherwise. In some embodiments, a movement of a head, eye or body part beyond an edge 116 of a function range 114 may also be ignored for purposes of function control. Such movement may be deemed to result from an accidental movement or a movement that is unrelated to or not intended to be interpreted as significant for purposes of function control. For example, a movement beyond an upper edge 116a may result from a user looking at a ceiling or at the sky, rather than the user intending to activate a function based on tracking of a head or eye.

In some embodiments, one or more of an ignore range 112, function range 114 and edge 116 may be established on vertical as well as horizontal axis, so that a slight lateral shaking of the head, whether accompanied by a change in a vertical position of the head, may both be detected as falling in an ignore range 112.

In some embodiments, upon a resting of an eye, head or body part following a movement of such body part, a center line 110, ignore range 112, function range 114 and edge 116 may be pulled and re-established around the same or some other body part upon or after the body part comes to a rest. For example, if a head is raised (counter clockwise) by 10 degrees relative to its prior position, then upon the head coming to a rest, one or more of a center line 110 or ignore range may be moved or gradually moved upward by a similar or comparable degree to establish a new and adjusted ignore range 112. Likewise, the new or adjusted ignore range 112 may also shift the function range 114 that may be derived from the new position of center line 110 or ignore range 112, or based on some other adjustment function.

In some embodiments, an adjustment in one or more of center line 110, ignore range 112 function range 114 may be trigger by any one or combination of a slowing or deceleration in a movement of a head, eye or body part, or a reversal in direction of a movement of the head eye or body part. Upon for example such slowing, one or more of center line 110, ignore range 112 or function range 114 may be pulled to or in the direction of the slowing movement, and ignore range 112 and function range may be likewise adjusted or pulled in such direction.

In some embodiments, a slow movement of for example a head may pull, or trigger an alteration in, a position or in coordinates or edges of ignore range 112 and function range 114. For example, if a head moves downward (clockwise) slowly, as may be defined by a change in degrees or in absolute or relative distance to imager 102 per each frame of image captured, the system may pull or trigger an alteration in the center line 110, ignore range 112 and function range 114, based on an assumption that the slow change in position is not to be interpreted as a movement for purposes of function control. Subsequent movements of the eye, head or body part from such altered ignored range 112 that are pronounced (in terms of speed, degree of angle or otherwise) or that extend into the altered position of the function range 114, may then be deemed as significant for purposes of function control.

Dynamically altering one or more of a center line 110, ignore range 112 and function range 114, to account for a prior movement of the imager, body part or both, may allow a system detect and interpret a significance of subsequent movements without necessitating a user to re-establish a starting point or resting point of the body part or imager.

In some embodiments, a decision by an embodiment of the system on whether to execute a function or, alternatively or in addition, whether to adjust center line 110, ignore range 112 or function range 114 may be delayed by several frames until, for example a system can detect with greater certainty whether the user intends his movement as a function or alternatively or in addition, whether such movement is to adjust or trigger an adjustment in ranges 112 or 114. In some embodiments the system may wait until it detects a stopping or slowing of a movement of the body part or imager 102. In some embodiments, the delay may be a predefined number of frames, an indication of a slowing of a movement of the user, or some other length. For example, a sudden movement of a head or eye may be detected but an adjustment of center line 110 and ignore range 112 may be delayed by a system until the head has come to a rest, slowed or reversed a direction.

In some embodiments, a shift of one or more of center line 110 and ignore range 112 may be replaced by or accompanied by a restructuring of the dimensions of for example one or more of ignore range 112 and function range 114. For example, if an eye or head of a user passed through the ignore range 112 without pausing, ignore range 110 may be extended in a direction of the motion of the user to allow for an unintentional over-shoot of the user through the prior ignore range. The ignore range 112 may assume asymmetrical around center line 110. For example, in a case where a user initially passes through an upper ignore range 112a and moves into function range 114, and then returns through upper ignore range 112, through center line 10 and through lower ignore range 112, without pausing. In such case, lower ignore range 112 may be extended asymmetrically to accommodate what may be an overshoot of the user. Once the user stops within the extended ignore range 112, the extension may be resized to include some or all of the extended ignore range 112. When the user leaves the extended ignore range 112 the extension may be removed and the ignore range 112 may return to its original size.

In some embodiments, a system may continue tracking of the eye, head or body part throughout its movement, even though the delay in resetting center line 110, ignore range 112 and function range 114 may be delayed by several frames until the slowing, or deceleration in movement is detected, until a pre-defined number of frames has passed, or until the system uses some other indication as a determination of an intention of a user in a movement.

In some embodiments a change in a position of a head or body part may be measured in two dimensions, such as in changes in pixel coordinates of a feature of the face in an image, rather than in angles, as might require a greater number of calculations from a processor.

In some embodiments, a system or method may delay an alteration or resetting of a range 112 or 114 or edge 116 based on a number of captured frames or duration or lapse of time that the center line 110 or other body part remained in the prior ignore range 112. For example, if a tip of a nose is initially within ignore range 112, and then there is a movement of the tip of the nose, the system may retain the current location and coordinates of the ignore range 112, and wait to see if the nose passed quickly out of the ignore range 112 and into the function range 114. If so, no adjustment in ranges may triggered, since the detected movement may be intentional for purposes of function control. If not, an evaluation of one or more of a speed, direction or acceleration/deceleration in the movement of the nose in the subsequent series of captured frames may indicate that the user did not intend (for purposes of function control based on tracking) to move, and that center line 110, ranges 112 and 114 and edges 116 are to be reset, to account for the new resting position and new starting position of the nose, or extended to include such new position or feature.

In some embodiments, the reset center line 110 and ignore range 112 may include the designated point (nose, eyes, etc.) that were included in the prior ignore range 112 so that a significance of further movements of such designated point from the new resting position may be determined. In some embodiments a rest may be interpreted as a trigger for range alteration only if such rest is within a designated area or proximity of imager 102. For example, a detected resting figure that is very far away from imager 102 may not trigger an range alteration since the distant user may not intend his movements to activate a function control.

In some embodiments, a size (in degrees or absolute number of pixels) of an ignore range 112 may be increased relative to a size of for example a function range 114 to account for a wide or large variability of positions of a user. For example a wide ignore range 112 may be established automatically for a user who has a consistent tremor of a head or an unsteady hand in holding an imager. In some embodiments, a size of an upper function range 114, or location of upper edge 116a may be increased relative to a size of a lower function range 114 or lower edge 116.

In some embodiments, various movements of a head, eye or body part may extend into a function range 114 but are in any case to be ignored by a system for purposes of function activation. For example, an initial movement of imager 102 into position in front of a face of a user may be detected by a system as a movement that extends into function range 114, even though the user is actually just holding up his phone or other device. To avoid such interpretation, one or more of center line 110 and ranges 112 and 114 may be established only upon a detected body part coming to rest. Similarly, detection of one or more fingers moving towards a screen is to be ignored for purposes of tracking and/or function activation. In some embodiments, detection of a finger moving towards a screen, or actually touching a screen may deactivate the function control described herein, and transfer such control to for example an input device such as a touch screen. Once the user stops touching the screen, or after a delay following such touching, the function control by eye tracking may be resumed or reset. Likewise activation of a screen saver or sleep mode of the device may deactivate a dynamic range alteration function and/or a function control of the eye/head tracking since the user is almost certainly not using the device when the screen is dark.

Further, it may be advisable to interpret a detection of a motion that is unexpected out of context or not compatible with motions being tracked by the application or tracking function as not being relevant for function control purposes. For example, if during a scrolling of images on a screen, the system detects a sideways or diagonal motion of the head, eyes or other body part, such motion may be deemed unexpected and may be ignored for function control purposes as well as for purposes of re-establishing a center line 110 and ranges 112 and 114. The function control or re-establishing of center line 110 and ranges 112 and 114 may be restarted or returned to a prior position or ranges once the motion ends, slows, decelerates or changes direction, or upon some other signal. For example, a delay may be imposed between a time of a frame where a motion in for example a function range is detected, and a time when the function association with such motion is implemented. During such delay, greater certainty may be achieved as to the intention of the user by for example analyzing a pattern of the user's movement. If such analysis indicates that the user intended to activate the function, then the function may be activated. If not, the function may not be activated, and/or the original ranges may be restored.

1. A system in accordance with the specification and drawings.

2. A method in accordance with the specification and drawings.
